(19) United States
(12) Patent Application Publication
(10) Pub. No.: US 2010/0040949 A1
(43) Pub. Date: Feb. 18, 2010

(54) COATING LIQUID FOR USE IN FORMATION OF POSITIVE ELECTRODE FOR LITHIUM SECONDARY BATTERY, POSITIVE ELECTRODE FOR LITHIUM SECONDARY BATTERY, AND LITHIUM SECONDARY BATTERY

(76) Inventors: Tetsuo Nanno, Osaka (JP); Tooru Matsui, Osaka (JP); Hiroshi Yoshizawa, Osaka (JP)

Correspondence Address: MCDERMOTT WILL & EMERY LLP, 600 13TH STREET, NW, WASHINGTON, DC, 20005-3096, US

(21) Appl. No.: 12/521,964

(22) PCT Filed: Nov. 21, 2008
(86) PCT No.: PCT/JP2008/003430

§ 371 Date: Jul. 1, 2009

(30) Foreign Application Priority Data
Dec. 14, 2007 (JP) 2007-323907

(51) Int. Cl. H01M 4/24

(52) U.S. Cl. 429/209

(57) ABSTRACT

A coating liquid for use in formation of a positive electrode for a lithium secondary battery of the present invention includes a large-particle-size active material having an average particle diameter of 1 to 20 μm and a small-particle-size active material having an average particle diameter of 5 to 100 nm, such that the blending ratio by volume between two materials is 90:10 to 50:50, and the average particle diameter ratio (the average particle diameter of large-particle-size active material/the average particle diameter of small-particle-size active material) is from 50 to 500. The coating liquid is excellent in storage stability over a long period of time and makes dense packing of active material possible, and therefore a positive electrode produced with the use of the coating liquid of the present invention can provide a lithium secondary battery having a high energy density and a high capacity.

### TECHNICAL FIELD

The present invention relates to a coating liquid for use in formation of a positive electrode for a lithium secondary battery, a positive electrode for a lithium secondary battery, and a lithium secondary battery. More specifically, the present invention mainly relates to improvements to a coating liquid for use in formation of a positive electrode for a lithium secondary battery.

### BACKGROUND ART

Non-aqueous electrolyte secondary batteries including a positive electrode active material capable of reversibly repeating absorption and desorption of lithium ions during charging and discharging have been proposed and have already been in practical use. The positive electrode for use in such non-aqueous electrolyte secondary batteries is generally produced by a production method including the steps of kneading, coating, rolling, and slitting. In the kneading step, a positive electrode material mixture paste is prepared by mixing and stirring a positive electrode active material, a conductive material, and a binder in a dispersion medium. In the coating step, the positive electrode material mixture paste prepared in the kneading step is applied onto a positive electrode core material and drying the paste, thereby to form a positive electrode active material layer carried on the positive electrode core material. In the rolling step, the positive electrode active material layer is rolled to be of a predetermined thickness, whereby a positive electrode plate is obtained. In the slitting step, the positive electrode plate is cut into a predetermined size.

Among the above steps, the quality of the positive electrode material mixture paste prepared in the kneading step has a significant influence on the performance of the finally obtained positive electrode plate. In particular, the dispersing state of solid components such as active material in the positive electrode material mixture paste is important. For example, there is a case where the positive electrode material mixture paste is left to stand in the duration from the preparation thereof to the application thereof to the positive electrode core material. In such a case, it is desired that the dispersing state of solid components shows little change with time and is stable. More specifically, it is desired that the positive electrode active material paste is such that the solid components therein will not precipitate with time, undergoes little change in viscosity, and has an appropriate level of thixotropy and a good coating ability.

In order to obtain a positive electrode material mixture paste having the above-listed properties, there have been made various proposals. For example, one proposal suggests using a lithium transition metal composite oxide as the positive electrode active material and preparing the positive electrode material mixture paste such that the ratio (B/A) of viscosity A (cp) of the positive electrode material mixture paste 30 minutes after homogenization to viscosity B (cp) of the positive electrode material mixture paste 2 hours after homogenization is 1.3 or less (see, for example, Patent Document 1). Here, homogenization is a process in which a positive electrode material mixture paste including 5 g of positive electrode active material is placed in a ball mill with a capacity of 45 mL and kneaded at 20° C. and 2500 rpm for 5 minutes. The positive electrode material mixture paste prepared according to this technique has an almost stable viscosity for about several hours after the preparation. However, according to this technique, it is difficult to obtain a positive electrode material mixture paste that has a stable viscosity over several days or a longer period of time. Moreover, although it is necessary to fill the positive electrode active material so as to be densely packed in the positive electrode active material layer in order to achieve a higher energy density and a higher capacity of a battery, according to this technique, it is difficult to fill the positive electrode active material to be at a satisfactory level.

Another proposal suggests a method for preparing a positive electrode material mixture paste by: adding a thickener dividedly twice or more times to the positive electrode active material and the conductive material, and kneading them; and subsequently adding a binder, and kneading them (see, for example, Patent Document 2). Further, Patent Document 2 discloses that the positive electrode active material and the conductive material are kneaded with the thickener through hard kneading in a funicular state followed by diluting and dispersing in a slurry state. By applying the positive electrode material mixture paste obtained by this technique onto a positive electrode core material, a positive electrode active material layer in which there are no coating lines and no agglomerates on the surface are present is formed. In addition, by using this positive electrode material mixture paste, a positive electrode plate capable of providing excellent battery performance can be produced with high yields and high productivity. However, in this technique, there is room for improvements in terms of dense packing of positive electrode active material, and so on.

With regard to the dense packing of active material also, various proposals have been made. For example, one proposal suggests an electrode containing two or more particulate active material groups having different average particle sizes, wherein the particulate active material group having the largest average particle size has particle diameters ranging from 4 to 50 μm (see, for example, Patent Document 3). Further, Patent Document 3 discloses, as a preferred embodiment, a configuration in which the average particle diameter of the particulate active material group having the smallest average particle size is 70% or less of the average particle diameter of the particulate active material group having the largest average particle size. According to this technique, it is expected that the small-particle-size active material particles enter the gaps between large-particle-size active material particles, whereby the active material density in the electrode is increased. However, in reality, the small-particle-size active material particles enter not only the gaps between large-particle-size active material particles and but also the space between adjacent large-particle-size active material particles, and therefore it is difficult to obtain the effect as expected.

Another proposal suggests a method for preparing of a positive electrode active material in which at least the surfaces of particles of a composite oxide containing lithium and a transition metal are melted and then solidified, followed by heating the solidified particles (see, for example, Patent Document 4). According to this technique, the particles of active material being the composite oxide containing lithium and a transition metal are sphericalized. As a result, the friction among the active material particles is reduced and the filling rate is improved, making a dense packing possible. However, it is impossible to achieve a sufficient level of dense packing simply by sphericalizing the active material particles. This is evident from a rigid sphere model. In the case of close packing of rigid spheres, the filling rate is as low as 74%.

It has been revealed, based on a rigid sphere model, that the packed density becomes the highest when, relative to 7 parts by weight of large-average-particle-size particles, 3 parts by weight of small-average-particle-size particles having an average particle diameter considerably smaller than that of the large-average-particle-size particles are used (see, for example, Non-Patent Document 1).
Patent Document 1: Japanese Laid-Open Patent Publication No. Hei 10-64518
Patent Document 2: Japanese Laid-Open Patent Publication No. 2000-348713
Patent Document 3: Japanese Laid-Open Patent Publication No. Hei 8-227708
Patent Document 4: Japanese Laid-Open Patent Publication No. 2002-110156
Non-Patent Document 1: Suzuki et al., Journal of Chemical Engineering of Japan 1985, Vol. 11, pp. 438-443

### DISCLOSURE OF THE INVENTION

### Problem To be Solved by the Invention

The present invention intends to provide a coating liquid for use in formation of a positive electrode for a lithium secondary battery, the coating liquid being excellent in storage stability and enabling a dense packing of active material, and to provide a positive electrode in which a positive electrode is densely packed, and a lithium secondary battery with high energy density and high capacity.

### Means for Solving the Problem

The present inventors have conducted intensive studies in order to solve the above-described problems, and found that using in combination two active materials each having a specific average particle diameter can provide a desired coating liquid for use in formation of a positive electrode for a lithium secondary battery. The present inventors have thus completed the invention.

Specifically, the present invention relates to a coating liquid for use in formation of a positive electrode for a lithium secondary battery (hereinafter simply referred to as a “coating liquid of the present invention”) comprising a large-particle-size active material having an average particle diameter of 1 μm to 20 μm and a small-particle-size active material having an average particle diameter of 5 nm to 100 nm, wherein the blending ratio by volume of the large-particle-size active material to the small-particle-size active material is from 90:10 to 50:50, and the ratio of the average particle diameter of the large-particle-size active material to the average particle diameter of the small-particle-size active material is from 50 to 500.

Preferably, the coating liquid of the present invention is a thixotropic fluid having a yield value of 100 Pa or higher.

Preferably, in the coating liquid of the present invention, the ratio η₁/η₂ of viscosity η₁ at 25° C. measured at a shear rate of 4/sec to viscosity n₂ at 25° C. measured at a shear rate of 40/sec is from 5 to 12.

The present invention further relates to a positive electrode for a lithium secondary battery (hereinafter simply referred to as a “positive electrode of the present invention”) including a positive electrode core material, and a positive electrode active material layer provided on one or both surfaces of the positive electrode core material in the thickness direction thereof, wherein

the positive electrode active material layer contains a large-particle-size active material having an average particle diameter of 1 μm to 20 μm and a small-particle-size active material having an average particle diameter of 5 nm to 100 nm, and has a filling rate of active material is 80% or more.

Preferably, in the positive electrode of the present invention, the blending ratio by volume of the large-particle-size active material to the small-particle-size active material is from 90:10 to 50:50, and the ratio of the average particle diameter of the large-particle-size active material to the average particle diameter of the small-particle-size active material is from 50 to 500.

Preferably, in the positive electrode of the present invention, the small-particle-size active material is predominantly present at a triple point in the large-particle-size active material.

Preferably, the positive electrode of the present invention is formed by applying the coating liquid of the present invention on one or both surfaces of the positive electrode core material in the thickness direction thereof and then drying.

The present invention relates to a lithium secondary battery including the positive electrode of the present invention.

### Effect of the Invention

The coating liquid of the present invention, even after stored over several days or even over a longer period of time, is very unlikely to cause precipitation or agglomeration of solid components and the like, and thus undergoes little change in viscosity, thixotropy, and the like that occurs in association with precipitation or agglomeration. Therefore, the coating liquid of the present invention is excellent in storage stability. Further, by applying the coating liquid of the present invention onto a positive electrode core material, a positive electrode active material layer in which an active material is densely packed can be formed. Furthermore, the coating liquid of the present invention exhibits good coating ability when applied onto a positive electrode core material, and, therefore, efficient coating thereof onto the positive electrode core material with little reduction in yield is enabled. As such, the coating liquid of the present invention is highly practical and industrially advantageous.

The positive electrode of the present invention, since having been formed with the use of the coating liquid of the present invention, has a positive electrode active material layer in which an active material is densely packed, and therefore is capable of contributing the achievement of a high energy density and a high capacity of a battery.

The lithium secondary battery of the present invention, since including the positive electrode of the present invention, has a considerably high energy density and capacity, and therefore is useful as a power source for various electric and electronic devices.

### BRIEF DESCRIPTION OF THE DRAWINGS

FIG. 1 is a set of cross-sectional views schematically showing a dispersing state of particles in the coating liquid immediately after preparation.

FIG. 2 is a set of cross-sectional views schematically showing how the dispersing state shown in FIG. 1 changes with time during storage.

FIG. 3 is a cross-sectional view schematically showing a dispersing state of the large-particle-size active material and the small-particle-size active material in an active material layer.

FIG. 4 is a scanning electron micrograph of a cross section of a positive electrode active material layer before rolling.

FIG. 5 is a scanning electron micrograph of a cross section of the positive electrode active material layer after rolling.

FIG. 6 is a graph showing the relationship between a shear rate and a viscosity in coating liquids of Examples 1 and Comparative Examples 1 to 2.

FIG. 7 is a graph showing the relationship between a shear rate and a shear stress in the coating liquids of Examples 1 and Comparative Examples 1 to 2.

FIG. 8 is a graph showing a change with time in viscosity after the application of shear force to the coating liquid of the present invention.

### BEST MODE FOR CARRYING OUT THE INVENTION

### [Coating Liquid for Use in Formation of Positive Electrode for Lithium Secondary Battery]

The most notable feature of the coating liquid of the present invention is using in combination a large-particle-size active material and a small-particle-size active material. The large-particle-size active material is composed of active material particles having an average particle diameter on the order of microns. The small-particle-size active material is composed of active material particles having an average particle diameter on the order of nanometers. As such, the average particle diameter of the small-particle-size active material is smaller than that of the large-particle-size active material.

In studying the stability of the coating liquid in relation to the precipitation, agglomeration, and the like of active material particles, the viscosity of the coating liquid is regarded as one of the main parameters that will affect the stability of the coating liquid. The viscosity of the coating liquid itself is greatly dependent on the average particle diameter of solid components such as the active material particles contained in the coating liquid.

In general, in the case where solid component particles having an average particle diameter on the order of microns (hereinafter simply referred to as “micron-size particles”) are used, the coating liquid will be a Newtonian fluid in which the viscosity is independent of shear forces, whereas the precipitation of micron-size particles proceeds rapidly, which is disadvantageous in terms of stability. On the other hand, in the case where solid component particles having an average particle diameter on the order of nanometers (i.e., primary particles, hereinafter simply referred to as “nano-size particles”) are used, a strong interaction exists between the nano-size particles, causing a high degree of thixotropy to appear. As such, it is difficult to prepare a coating liquid in which the concentration of nano-size particles is high. On the other hand, by using a commonly known dispersing method, it is impossible to completely prevent the agglomeration of nano-size particles. For this reason, the resultant coating liquid exhibits fluid characteristics dependent on the average particle diameter of secondary particles composed of agglomerates of nano-size particles. The secondary particles usually have an average particle diameter on the order of microns, and hence behave similarly to the micron-size particles. In other words, even when the nano-size particles are used, the resultant coating liquid has almost the same characteristics as those of a coating liquid obtained when the micron-size particles are used. Therefore, even when the nano-size particles are used, it is difficult to obtain a coating liquid with excellent stability, since the precipitation of secondary particles proceeds in the coating liquid.

In contrast, the coating liquid of the present invention contains a large-particle-size active material having an average particle diameter on the order of microns and a small-particle-size active material having an average particle diameter on the order of nanometers. Therefore, it is generally predicted that the coating liquid of the present invention exhibits fluid characteristics intermediate between those of a coating liquid containing micron-size particles (hereinafter referred to as a “micron-size coating liquid”) and those of a coating liquid containing nano-size particles (hereinafter referred to as a “nano-size coating liquid”). However, contrary to this prediction, the coating liquid of the present invention exhibits a higher degree of thixotropy than the nano-size coating liquid, and has fluid characteristics unique in that a high level of stability is maintained over a long period of time.

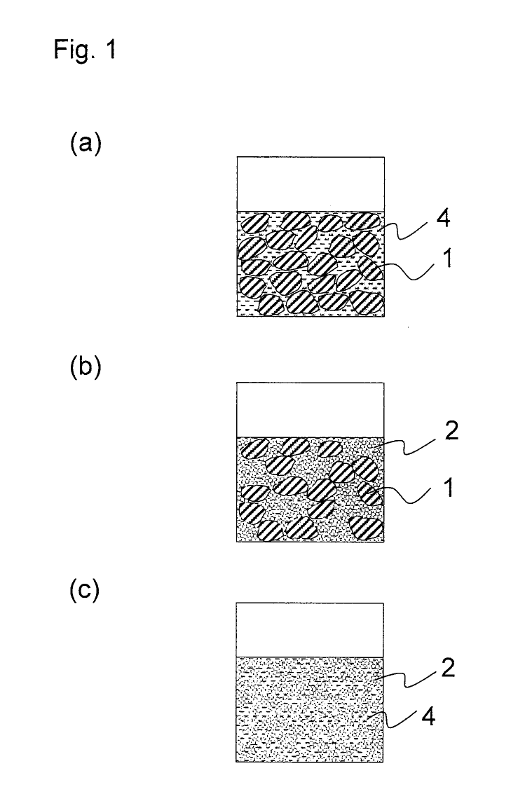

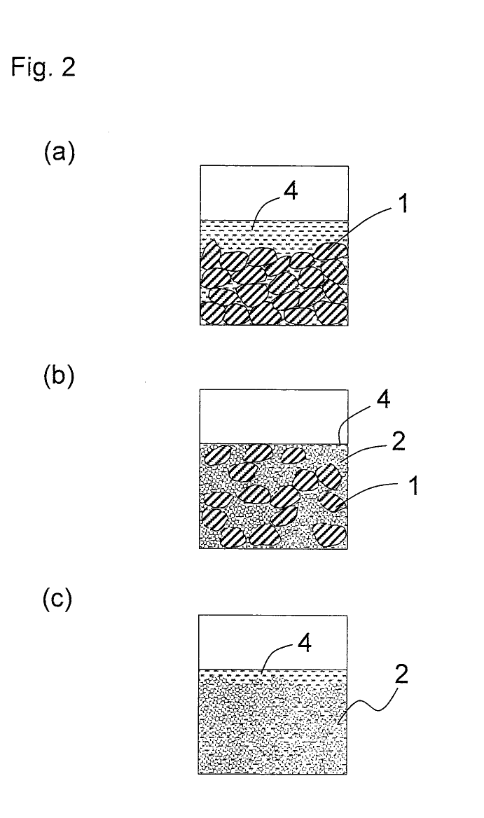

FIG. 1 is a set of cross-sectional views schematically showing a dispersing state of various sizes of particles in the coating liquid immediately after preparation. FIG. 2 is a set of cross-sectional views schematically showing how the dispersing state shown in FIG. 1 changes with time during storage. FIG. 1(a) and FIG. 2(a) show a dispersing state of micron-size particles. FIG. 1(b) and FIG. 2(b) show a dispersing state in which micron-size particles and nano-size particles are co-present. FIG. 1(c) and FIG. 2(c) show a dispersing state of nano-size particles.

In the coating liquid in which either micron-size particles or nano-size particles are present alone, immediately after the preparation of coating liquid, the particles are dispersed evenly in the coating liquid. However, during storage of the coating liquid, precipitation proceeds in the case of micron-size particles, and precipitation associated with agglomeration proceeds in the case of nano-size particles. In contrast, in the coating liquid in which micron-size particles and nano-size particles are co-present, even after storage, the dispersing state similar to that immediately after the preparation of coating liquid is maintained. This is presumably attributed to the following reasons.

Since micron-size particles and nano-size particles are co-present, the dispersion of the nano-size particles and the deagglomeration of the secondary particles being agglomerates of the nano-size particles are facilitated by the aid of the micron-size particles. Further, the dispersed nano-size particles are mainly present in the gaps between micron-size particles, forming a network structure composed of aggregated nano-size particles. In association with this, the physical interaction between the micron-size particles and the nano-size particles acts and suppresses the flow of each particle, and therefore the change in the dispersing state in the coating liquid hardly occurs even after storage over a long period of time. As such, the state in which there is little change in the viscosity of the coating liquid is maintained over a long period of time. Presumably for this reason, despite the presence of micron-size particles, it is possible to obtain a stable coating liquid in which precipitation of particles is unlikely to occur.

The reasons why the nano-size particles form a network structure include that: the smaller the average particle diameter is, the smaller the dispersion stabilizing effect due to electrostatic repulsion is; when primary particles that have been mechanically dispersed are bound, linear bonding is energetically advantageous; and other reasons. These are discussed in, for example, “Current Pigment Dispersion Technology”, edited by Technical Information Institute Co., Ltd., 1995, p. 67.

The coating liquid of the present invention contains a dispersion medium in addition to the large-particle-size active material and the small-particle-size active material, and has the following features (1) to (3).

(1) The large-particle-size active material has an average particle diameter of 1 to 20 μm, and preferably 2 to 10 μm. The small-particle-size active material has an average particle diameter of 5 to 100 nm, and preferably 10 to 70 nm.

When the large-particle-size active material has an average particle diameter of less than 1 μm, a dense packing of active material to such a degree as to be capable of contributing to the improvement of the battery performance may be disabled. On the other hand, when the large-particle-size active material has an average particle diameter of more than 20 μm, the charge-discharge efficiency of a lithium secondary battery produced with the use of the coating liquid of the present invention may deteriorate.

When the small-particle-size active material has an average particle diameter of less than 5 nm, the majority of the small-particle-size active material is present as primary particles, and thus the small-particle-size active material shows a strong tendency to agglomerate. As a result, the agglomeration of the small-particle-size active material easily occurs. Since an agglomerate of small-particle-size active material has a large number of gaps in the interior thereof, a dense packing of active material to such a degree as to be capable of contributing to the improvement of the battery performance may be disabled. On the other hand, when the small-particle-size active material has an average particle diameter of more than 100 nm, the amount of the small-particle-size active material that can be present at a triple point in the large-particle-size active material is reduced, and therefore, in this case also, a dense packing of active material to such a degree as to be capable of contributing to the improvement of the battery performance may be disabled.

The triple point in the large-particle-size active material as used herein means a gap portion surrounded by the large-particle-size active material. Such a gap portion is formed when the large-particle-size active material is present in such a state that the particles thereof are in contact with one another.

(2) The blending ratio of the large-particle-size active material to the small-particle-size active material (large-particle-size active material: small-particle-size active material, ratio by volume) is from 90:10 to 50:50, and preferably from 80:20 to 60:40.

Specifically, relative to the overall volume obtained by totaling the volume of the large-particle-size active material and the volume of the small-particle-size active material, the blending amount of the large-particle-size active material is 50 to 90% by volume, and preferably 60 to 80% by volume, with the remainder being the small-particle-size active material. When the large-particle-size active material and the small-particle-size active material are blended in the above ratio, the small-particle-size active material is closely embedded in the triple points in the large-particle-size active material, and therefore a dense packing of active material is enabled. When the blending amount of the large-particle-size active material is less than 50% by volume or more than 90% by volume, a dense packing of active material to such a degree as to be capable of contributing to the improvement of the battery performance may be disabled.

The volumes of the large-particle-size active material and the small-particle-size active material as used herein each mean a volume occupied by the active material. The occupied volume is determined by dividing the weight of an active material powder by the true density (specific gravity) of the active material powder. Accordingly, in the case where the large-particle-size active material and the small-particle-size active material are the same compound, since the true densities thereof are the same, the blending ratio (ratio by volume=occupied volume ratio) of the large-particle-size active material to the small-particle-size active material is equal to the ratio by weight of the large-particle-size active material to the small-particle-size active material.

(3) The ratio of the average particle diameter of the large-particle-size active material to the average particle diameter of the small-particle-size active material (the average particle diameter of the large-particle-size active material/the average particle diameter of the small-particle-size active material; hereinafter simply referred to as the “average particle diameter ratio”) is from 50 to 500, preferably from 50 to 250, and more preferably from 50 to 200. When the average particle diameter ratio is within the above range, the large-particle-size active material is packed in the form similar to a closest-packing, and moreover in the triple points in the large-particle-size active material, the small-particle-size active material is closely packed. Consequently, the filling rate of active material reaches as high as 80% or more, realizing a dense packing of active material.

When the average particle diameter ratio is less than 50, the triple points in the large-particle-size active material are not sufficiently filled with the small-particle-size active material, and the gaps are partially left unfilled. As such, the filling rate is reduced and thus the dense packing may be disabled. On the other hand, when the average particle diameter ratio is more than 500, the small-particle-size active material shows a strong tendency to agglomerate, and the agglomerates of the small-particle-size active material become large in size, failing to enter the triple points. As a result, the gap portions being the triple points cannot be sufficiently filled with the small-particle-size active material. Therefore, the filling rate of active material is reduced, and a dense packing in which the filling rate is 80% or more may not be realized.

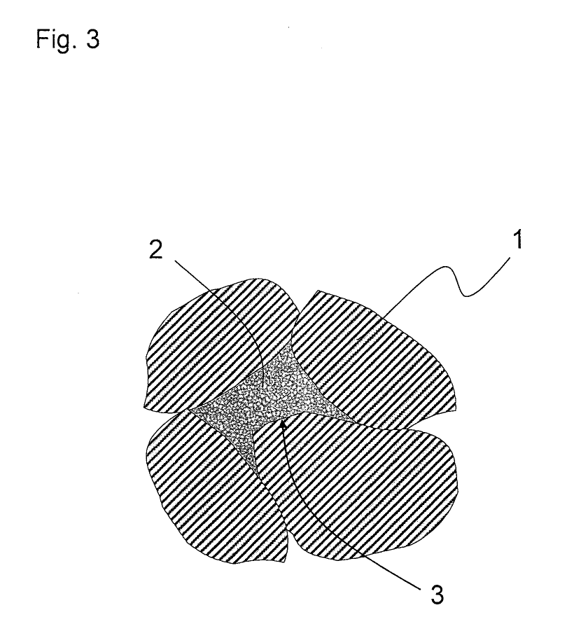

In the present invention, since the large-particle-size active material and the small-particle-size active material satisfy the above-described features (1) to (3), the triple points in the large-particle-size active material are closely filled with the small-particle-size active material. Presumably for this reason, the filling rate of active material is improved, that is, a dense packing of active material is achieved. It is presumed that the large-particle-size active material and the small-particle-size active material are arranged and packed as shown in FIG. 3. FIG. 3 is a cross-sectional view schematically showing a dispersing state of the large-particle-size active material and the small-particle-size active material in an active material layer. A triple point 3 surrounded by a large-particle-size active material 1 is formed because of the presence of the large-particle-size active material 1 in such a state that the particles thereof are in contact with one another. In the triple point 3, a small-particle-size active material 2 whose average particle diameter is extremely smaller than that of the large-particle-size active material 1 is closely packed. It is considered that, as a result, the porosity in the active material layer is lowered, a dense packing of active material is realized, and thus the battery performance, such as the energy density and the capacity, can be improved.

As for the large-particle-size active material and the small-particle-size active material, any positive electrode active material which is commonly used in a lithium secondary battery and is capable of absorbing and desorbing lithium ions may be used. Preferred example of the positive electrode active material include a layered oxide containing Li and having a rock-salt-type-structure, such as LiCoO₂, LiNiO₂, LiMnO₂, and a solid solution containing at least one of these; a spinel-type oxide, such as LiMn₂O₄, and Li(MnM)₂O₄, where M is Ni, Co, Fe or the like; an olivine-type oxide, such as LiFePO₄; and the like. For the large-particle-size active material, one or two or more selected from positive electrode active materials commonly used in a lithium secondary battery may be used. As for the small-particle-size active material also, one or two or more selected from positive electrode active materials commonly used in a lithium secondary battery may be used.

The large-particle-size active material and the small-particle-size active material can be prepared by pulverizing a positive electrode active material commonly used in a lithium secondary battery to a predetermined average particle diameter using a powder pulverizer. As for the pulverizer, any commonly used one may be used, examples of which include a cutter mill, a feather mill, a jet mill, a particle-collision-type jet mill, a fluidized-bed-type jet pulverizer, and the like. These powder pulverizers are commercially available.

Alternatively, the small-particle-size active material can be prepared by applying synthesizing methods of nano-size particles that have been under recent study. For example, synthesizing methods of nano-size LiCoO₂ are reported in the Collection of 48th Battery Symposium Lecture Summaries, pp. 2-3 (Miyake et al.) and ibid., pp. 4-5 (Ohkubo et al.). For example, Miyake et al. report that LiCoO₂ having particle diameters on the order of nanometers can be obtained by allowing a lithium compound and a cobalt compound to react at an elevated temperature of about 300° C. in the presence of a basic molten salt of lithium. Here, as the lithium compound, for example, lithium peroxide (Li₂O₂) and the like may be used. As the cobalt compound, for example, cobalt hydroxide and the like may be used. As the basic molten salt, for example, a basic molten salt of lithium hydroxide-lithium nitrate (LiOH.H₂O—LiNO₃) and the like may be used. Further, Ohkubo et al. report that LiCoO₂ having particle diameters on the order of nanometers can be obtained by performing hydrothermal synthesis with the use of a lithium compound and a cobalt compound.

The average particle diameters of the large-particle-size active material and the small-particle-size active material as used herein each mean an average particle diameter of primary particles. Accordingly, primary particles are used for the large-particle-size active material and the small-particle-size active material. In the present invention, the average particle diameter of primary particles is measured by observing the large-particle-size active material and the small-particle-size active material under a scanning electron microscope to measure the equivalent area circle diameters of randomly selected 100 particles, and averaging the measured values of the 100 particles. Alternatively, in the case where the primary particles are too small to measure the particle diameters thereof under a scanning electron microscope, the primary particles is observed under a transmission-type electron microscope at a higher magnification to measure the equivalent area circle diameters of the primary particles. It should be noted that it is inappropriate to use a laser diffraction/scattering type particle size distribution analyzer, which is commonly used for particle size distribution measurement, because the results are influenced by aggregated particles and cannot reflect the correct particle diameters of primary particles.

In the present invention, even in the case of secondary particles composed of aggregated primary particles, if the tensile strength of the secondary particles is 50 MPa or more, these secondary particles may be used as the primary particles of the present invention. In this case, on the basis of the average particle diameter of secondary particles, the large-particle-size active material and the small-particle-size active material can be selected and mixed in a predetermined ratio. The secondary particles having an above tensile strength will not be broken in the steps of preparing a coating liquid for use in formation of an electrode, applying the coating liquid for use in formation of an electrode, and other steps, and therefore can be used as the primary particles of the present invention.

It should be noted that the average particle diameter of secondary particles can be measured with a commonly used laser diffraction/scattering type particle diameter distribution analyzer. Alternatively, the average particle diameter may be determined in the same manner as the average particle diameter of primary particles is determined.

The tensile strength (St) of secondary particles can be determined by: subjecting the secondary particles to compression test using a micro compression testing machine (Trade name: MCT-W501, available from Shimadzu Corporation) to measure a compressive force (P) at which a second particle breaks and a projected circle equivalent particle diameter (d) of the second particle at the time of breakage, and calculating from the following formula taught by Hiramatsu et al.

St=2.8 P/πd²,

where St is a tensile strength (MPa), P is a compressive force (N) at which a second particle breaks, and d is a projected circle equivalent particle diameter (mm) of the second particle at the time of breakage.

The coating liquid of the present invention is preferably a thixotropic fluid having a yield value of 100 Pa or higher. The yield value is a value obtained by externally applying stress to a material and measuring a value of the stress at which the material starts flowing. Since the coating liquid of the present invention has a yield value of 100 Pa or higher, the storage stability of the coating liquid of the present invention is further improved. If the yield value is less than 100 Pa, the interaction between the active material particles is reduced, and therefore the fluidity of the active material particles may be increased more than necessary. As a result, during the storage of the coating liquid over a long period of time, the coating liquid undergoes a great change in viscosity, and thus tends to cause precipitation, agglomeration, or the like of the active material, which may cause the internal structure, the film thickness, and the like of an active material layer formed from the coating liquid to vary.

In the coating liquid of the present invention, the ratio η₁/η₂ of viscosity η₁ (25° C.) measured at a shear rate of 4/sec to viscosity η₂ (25° C.) measured at a shear rate of 40/sec is preferably from 5 to 12. By adjusting the ratio η₁/η₂, which is an index representing the thixotropy, within the above range, it is possible to further improve the coating film formability, the leveling ability, and the like of the coating liquid of the present invention.

When η₁/η₂ is less than 5, the viscosity of the coating liquid is lowered, and in a coating film formed by applying the coating liquid, the coating liquid may drip from the edge of the coating film. In addition, the thickness of the coating film becomes difficult to control, and the coating accuracy may deteriorate. Moreover, the storage stability of the coating liquid may be reduced. On the other hand, when η₁/η₂ is more than 12, the leveling ability, the coating film formability, and the like may deteriorate to cause a severe uneven coating, and thus a pinhole may occur.

It should be noted that η₁ and η₂ are values measured at 25° C. using Programmable Rheometer (Model No.: DV-III+, available from Brookfield Engineering Laboratories, Inc).

In the present invention, by appropriately adjusting the average particle diameters of the large-particle-size active material and the small-particle-size active material, the blending ratio of the large-particle-size active material to the small-particle-size active material, the total solids concentration in the coating liquid, and the like within a predetermined range, it is possible to prepare a coating liquid of the present invention having a yield value of 100 Pa or higher, or having a ratio η₁/η₂ is from 5 to 12, or having the both properties.

The coating liquid of the present invention contains a dispersion medium in addition to the large-particle-size active material and the small-particle-size active material. As for the dispersion medium, it is possible to use any one appropriately selected from dispersion mediums (organic solvents) commonly used in the field of lithium secondary batteries, according to the volatility, the ability to dissolve or disperse other components, and the like. Examples of such a dispersion medium include, for example, amides, such as dimethylformamide, dimethylacetamide, and methylformamide; amines, such as N-methyl-2-pyrrolidone (NMP), and dimethylamine; ketones, such as methyl ethyl ketone, acetone, and cyclohexanone, and the like. Among these, NMP, methyl ethyl ketone; and the like are preferred. These dispersion mediums may be used alone or, as needed, in combination of two or more.

The content of the dispersion medium in the coating liquid of the present invention is not particularly limited and may be appropriately selected according to the types and blending ratios of other components, the type of the dispersion medium itself, and the like, but preferably is 20 to 50% by weight of the total amount of the coating liquid, and more preferably 25 to 40% by weight of the total amount of the coating liquid. When the content of the dispersion medium is less than 20% by weight, the coating liquid becomes extremely viscous, and the leveling ability of the coating liquid is reduced, which may result in a defective coating film formation. On the other hand, when the content of the dispersion medium is more than 50% by weight, the large-particle-size active material and the small-particle-size active material are not uniformly dispersed in the active material layer, and the active material layer contains a larger number of gaps, which may result in a lowered packed density of active material.

The coating liquid of the present invention may contain a conductive material, a binder, and the like as needed in addition to the large-particle-size and small-particle-size active materials and the dispersion medium. The conductive material and the binder are solid components other than the large-particle-size and small-particle-size active materials.

As for the conductive material, any one commonly used in the field of lithium secondary batteries may be used, examples of which include graphites, such as natural graphite, and artificial graphite; carbon blacks, such as acetylene black, Ketjen black, channel black, furnace black, lamp black, and thermal black; electrically conductive fibers, such as carbon fiber and metallic fiber; metallic powders, such as fluorinated carbon powder and aluminum powder; electrically conductive whiskers such as zinc oxide whisker and potassium titanate whisker; electrically conductive metal oxides, such as titanium oxide; electrically conductive organic materials, such as phenylene derivatives; and the like. These conductive materials may be used alone or, as needed, in combination of two or more.

The binder dissolves or disperses in the dispersion medium. The active material (the large-particle-size active material and the small-particle-size active material) and the conductive material also disperse in the dispersion medium. Accordingly, by appropriately changing at least one of the contents of the binder, active material, conductive material, and the like, the viscosity of the coating liquid of the present invention can be controlled. It is preferable, however, to control the viscosity of the coating liquid by selecting a binder which is capable of dissolving in the dispersion medium, and appropriately changing the content of this binder.

As for the binder also, any one which is commonly used in the field of lithium secondary batteries and is capable of dissolving or dispersing in the dispersion medium may be used. Examples of such a binder include fluorocarbon resin, polyethylene, polypropylene, aramid resin, polyamide, polyimide, polyamide-imide, polyacrylonitrile, polyacrylic acid, polymethyl acrylate, polyethyl acrylate, polyhexyl acrylate, poly methacrylic acid, polymethyl methacrylate, polyethyl methacrylate, polyhexyl methacrylate, polyvinyl acetate, polyvinylpyrrolidone, polyether, polyether sulfone, hexafluoropolypropylene, styrene-butadiene rubber, carboxymethylcellulose, and the like. Among these, fluorocarbon resin is preferred. The content of the conductive material in the coating liquid of the present invention is not particularly limited, but preferably is 1 to 7 parts by weight per 100 parts by weight of the active material (the total amount of the large-particle-size active material and the small-particle-size active material).

Examples of the fluorocarbon resin include a polymer of a fluorine-containing monomer compound, a copolymer of a fluorine-containing monomer compound and another monomer compound, and the like. The fluorine-containing monomer compound is exemplified by tetrafluoroethylene, hexafluoropropylene, perfluoroalkyl vinylether, vinylidene fluoride, chlorotrifluoroethylene, pentafluoropropylene, fluoromethyl vinyl ether, and the like. Among these, vinylidene fluoride, hexafluoropropylene, chlorotrifluoroethylene, tetrafluoroethylene, and the like are preferred. Another monomer compound is exemplified by ethylene, propylene, acrylic acid, hexadiene, and the like. These fluorine-containing monomer compounds and another monomer compound may be respectively used alone or in combination of two or more.

Specific examples of the fluorocarbon resin include polyvinylidene fluoride (PVDF), polytetrafluoroethylene, vinylidene fluoride-hexafluoro propylene copolymer, vinylidene fluoride-chlorotrifluoroethylene copolymer, vinylidene fluoride-tetrafluoroethylene copolymer, and the like.

The content of the binder in the coating liquid of the present invention is not particularly limited, but preferably is 1.5 to 6 parts by weight per 100 parts by weight of the active material (the total amount of the large-particle-size active material and the small-particle-size active material). When the content of the binder is within the above range, the mixed particles of the large-particle-size active material and the small-particle-size active material are elastically bound to one another in the coating liquid. As a result, the precipitation of the particles during storage is suppressed and the viscosity is less varied with time, which can contribute to the increase in storage stability of the coating liquid.

When the content of the binder is less than 1.5 parts by weight, the dispersibility of the small-particle-size active material is reduced in the kneading step in preparation of coating liquid, and the aggregation of particles of the small-particle-size active material is accelerated to cause the fluidity of the coating liquid to deteriorate, and as a result the viscosity of the coating liquid may be increased. Moreover, the large-particle-size active material and the small-particle-size active material are not uniformly mixed, failing to provide a uniform coating film and to perform a dense packing of active material. Furthermore, the adhesion between the positive electrode core material and the active material layer is reduced, and the active material and the like may be separated from the positive electrode core material. On the other hand, when the content of the binder is more than 6 parts by weight, the proportion of the active material in the positive electrode is decreased, and the capacity of the battery may be reduced.

The coating liquid of the present invention can be prepared, for example, by mixing the large-particle-size active material, the small-particle-size active material, and, as needed, additional materials, such as the conductive material and the binder, with the dispersion medium to dissolve or disperse these materials in the dispersion medium. In mixing materials, a mixer is generally used. As for the mixer, a commercially available mixer that can be used for mixing powder and liquid may be used. The mixer may be of a batch type or of a continuous type.

### [Positive Electrode for Lithium Secondary Battery]

The positive electrode for a lithium secondary battery of the present invention (hereinafter simply referred as the “positive electrode of the present invention”) includes a positive electrode core material, and a positive electrode active material layer provided on one or both surfaces of the positive electrode core material, wherein the positive electrode active material layer contains a large-particle-size active material having an average particle diameter of 1 μm to 20 μm and a small-particle-size active material having an average particle diameter of 5 nm to 100 nm, and the filling rate of active material is 80% or more, and preferably 80 to 90%.

The positive electrode of the present invention can be produced, for example, in the following manner. First, the coating liquid of the present invention is applied onto one or both surfaces of the positive electrode core material in its thickness direction, and then dried, so that a positive electrode active material layer is formed on the surface(s) of the positive electrode core material. A positive electrode plate is thus produced. This positive electrode plate may be used as it is as the positive electrode of the present invention. Alternatively, the positive electrode active material layer may be rolled to adjust its thickness, followed by cutting to a predetermined size, whereby a desired positive electrode plate is produced.

As for the positive electrode core material, any one commonly used in the field of lithium secondary batteries may be used, examples of which include a porous or non-porous electrically conductive substrate sheet made of metallic material, such as stainless steel, titanium, aluminum, and aluminum alloy. The thickness of the conductive substrate sheet is not particularly limited, but preferably is 1 to 50 μm, and more preferably 5 to 20 μm. By using a substrate sheet having a thickness within the above range, it is possible to achieve a reduction in weight, while maintaining the mechanical strength of the positive electrode core material and thus maintaining the mechanical strength of the lithium secondary battery.

The thickness of the positive electrode active material layer is not particularly limited, and may be appropriately selected according to various conditions, such as the type and the content in the active material layer of the positive electrode active material, the configuration of the negative electrode and the separator, and the use of the lithium secondary battery. For example, in the case of forming the positive electrode active material layer is formed on one surface of the positive electrode core material, the thickness is about 10 to 200 μm. In the case of forming the positive electrode active material layer on both surfaces of the positive electrode core material, the thickness is about 20 to 400 μm in total.

It should be noted that by using the coating liquid of the present invention to form a positive electrode active material layer, a dense packing in which the filling rate of active material in the positive electrode active material layer is 80% or more is achieved.

### [Lithium Secondary Battery]

The lithium secondary battery of the present invention may have the same configuration as that of the conventional lithium secondary battery except that the positive electrode of the present invention is used in place of the conventional positive electrode. The lithium secondary battery of the present invention includes, for example, a positive electrode, a negative electrode, a separator, and a non-aqueous electrolyte. The positive electrode is the positive electrode of the present invention.

The negative electrode is disposed so as to be opposite the positive electrode with the separator interposed therebetween, and includes, for example, a negative electrode core material and a negative electrode active material layer. More specifically, the negative electrode is disposed such that the negative electrode active material layer faces the separator. As for the negative electrode core material, any one commonly used in the field of lithium secondary batteries may be used, examples of which include a porous or non-porous electrically conductive substrate sheet made of metallic material, such as stainless steel, nickel, copper, and copper alloy. The thickness of the conductive substrate sheet is not particularly limited, but preferably is 1 to 50 μm, and more preferably 5 to 20 μm. By using a substrate sheet having a thickness within the above range, it is possible to achieve a reduction in weight, while maintaining the mechanical strength of the negative electrode core material and thus maintaining the mechanical strength of the lithium secondary battery.

The negative electrode active material layer contains a negative electrode active material and is provided on one or both surfaces of the negative electrode core material in its thickness direction. As for the negative electrode active material, any one commonly used in the field of lithium secondary batteries may be used, examples of which include a metal, a metallic fiber, a carbon material, an oxide, a nitride, silicon, a silicon compound, tin, a tin compound, various alloy materials, and the like. Among these, in view of the magnitude of the capacity density, a carbon material, silicon, a silicon compound, tin, a tin compound, and the like are preferred. The carbon material is exemplified by various natural graphites, coke, partially-graphitized carbon, carbon fiber, spherical carbon, various artificial graphites, amorphous carbon, and the like. The silicon compound is exemplified by a silicon-containing alloy, a silicon-containing inorganic compound, a silicon-containing organic compound, a solid solution, and the like. Specifically, the silicon compound may be, for example, silicon oxide represented by SiOₐ, where 0.05<a<1.95; an alloy containing silicon and at least one element selected from Fe, Co, Sb, Bi, Pb, Ni, Cu, Zn, Ge, In, Sn, and Ti; a silicon compound or a silicon-containing alloy in which a part of silicon contained in the silicon, the silicon oxide or the alloy is replaced with at least one element selected from B, Mg, Ni, Ti, Mo, Co, Ca, Cr, Cu, Fe, Mn, Nb, Ta, V, W, Zn, C, N, and Sn; a solid solution of these materials; and the like. The tin compound is exemplified by SnO_{b}, where 0<b<2, SnO₂, SnSiO₃, Ni₂Sn₄, Mg₂Sn, and the like. These negative electrode active materials may be used alone or, as needed, in combination of two or more.

The negative electrode can be produced, for example, by applying a coating liquid for use in formation of a negative electrode containing the negative electrode active material on a surface of the negative electrode core material, and then drying to form a negative electrode active material layer. The coating liquid for use in formation of a negative electrode contains, for example, the negative electrode active material, a binder, an organic solvent, and the like. Here, the binder and the organic solvent may be appropriately selected from the examples of the binders and the organic solvents that may be used in preparing a positive electrode material mixture slurry. The coating liquid for use in formation of a negative electrode can be prepared, for example, by dissolving or dispersing the negative electrode active material, the binder, and the like in the organic solvent. In the case where the coating liquid for use in formation of a negative electrode contains the negative electrode active material and the binder as solid components, the blending ratio of the negative electrode active material is preferably 90 to 99.5% by weight of the total amount of solid components, and the blending ratio of the binder is preferably 0.5 to 10% by weight of the total amount of solid components.

In the case of using silicon, a silicon compound, tin, a tin compound, and the like as the negative electrode active material, a vapor deposition method can be used to form a thin film of negative electrode active material layer on a surface of the negative electrode core material, thereby to obtain the negative electrode. Examples of such a vapor deposition method include vacuum deposition, chemical vapor deposition, sputtering, ion plating, and the like.

The separator is disposed between the positive electrode and the negative electrode. As for the separator, for example, a sheet or film separator having a predetermined degree of ion permeability, as well as a mechanical strength, an insulating property, and the like may be used. The separator is specifically exemplified by a porous separator in the form of sheet or film, such as a microporous film, a woven fabric, a non-woven fabric, and the like. The microporous film may be of a single-layer film or of a multi-layer film (a composite film). The single-layer film is made of one material. The multi-layer film (the composite film) is a laminate of single-layer films made of one material or a laminate of single-layer films made of different materials.

As the material of the separator, various resin materials may be used, but polyolefin, such as polyethylene and polypropylene, is preferred in view of the durability, the shutdown function, the safety of the battery, and the like. Here, the shutdown function is a function that works when the battery temperature is abnormally elevated, in such a way that the throughpores are closed to interrupt the migration of ions, thereby to shut down the battery reaction. The separator, as needed, may be formed of two or more layers of microporous film, woven fabric, non-woven fabric, and the like. The thickness of the separator is generally 10 to 300 μm, and is preferably 10 to 40 μm, more preferably 10 to 30 μm, and more preferably 10 to 25 μm. The porosity of the separator is preferably 30 to 70%, and more preferably 35 to 60%. Here, the porosity is a ratio of the total volume of pores present in the separator to the volume of the separator.

Examples of the non-aqueous electrolyte include a liquid non-aqueous electrolyte, a gelled non-aqueous electrolyte, a solid electrolyte (e.g., a polymer solid electrolyte), and the like.

The liquid non-aqueous electrolyte includes a solute (a support salt) and a non-aqueous solvent, and further includes, as needed, various additives. The solute usually dissolves in the non-aqueous solvent. The liquid non-aqueous electrolyte is impregnated, for example, into the separator.

As for the solute, any material commonly used in this field may be used, examples of which include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, chloroborane lithium, boric acid salts, imide salts, and the like. The boric acid salts are exemplified by lithium bis(1,2-benzendioleate(2-)-0,0′) borate, lithium bis(2,3-naphthalenedioleate(2-)-0,0′) borate, lithium bis(2,2′-biphenyldioleate(2-)-0,0′) borate, lithium bis(5-fluoro-2-oleate-1-benzenesulfonate-0,0′) borate, and the like. The imide salts are exemplified by lithium bis(trifluoromethyl sulfonyl)imide ((CF₃SO₂)₂NLi), lithium (trifluoromethyl sulfonyl)(nonafluorobutyl sulfonyl)imide ((CF₃SO₂)(C₄F₉SO₂)NLi), and lithium bis(pentafluoroethyl sulfonyl)imide ((C₂F₅SO₂)₂NLi), and the like. These solutes may be used alone or, as needed, in combination of two or more. The amount of solute to be dissolved in the non-aqueous solvent is preferably within a range from 0.5 to 2 mol/L.

As for the non-aqueous solvent, any one commonly used in this field may be used, examples of which include cyclic carbonic acid ester, chain carbonic acid ester, cyclic carboxylic acid ester, and the like. The cyclic carbonic acid ester is exemplified by propylene carbonate (PC), ethylene carbonate (EC), and the like. The chain carbonic acid ester is exemplified by diethyl carbonate (DEC), ethyl methyl carbonate (EMC), dimethyl carbonate (DMC), and the like. The cyclic carboxylic acid ester is exemplified by γ-butyrolactone (GBL), γ-valerolactone (GVL), and the like. These non-aqueous solvents may be used alone or, as needed, in combination of two or more.

As for the additive, for example, a material for improving the charge-discharge efficiency, a material for inactivating a battery, and the like may be used. The material for improving the charge-discharge efficiency improves the charge-discharge efficiency by, for example, decomposing on the negative electrode to form a coating film excellent in lithium ion conductivity. Examples of such a material include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinylethylene carbonate (VEC), divinylethylene carbonate, and the like. These may be used alone or in combination of two or more. Among these, at least one selected from vinylene carbonate, vinylethylene carbonate, and divinylethylene carbonate is preferred. In the above-listed compounds, part of hydrogen atoms may be replaced with fluorine atoms.

The material for inactivating a battery inactivates a battery, for example, by decomposing during over charge of the battery to form a coating film on the electrode. Examples of such a material include a benzene derivative. The benzene derivative is exemplified by a benzene compound having a phenyl group and a cyclic compound group adjacent to the phenyl group. Preferred examples of the cyclic compound group include a phenyl group, a cyclic ether group, a cyclic ester group, a cycloalkyl group, a phenoxy group, and the like. The benzene derivative is specifically exemplified by cyclohexyl benzene, biphenyl, diphenyl ether, and the like. These benzene derivatives may be used alone or in combination of two or more. It should be noted, however, that the content of benzene derivative in a liquid non-aqueous electrolyte is preferably equal to or less than 10 parts by volume per 100 parts by volume of the non-aqueous solvent.

The gelled non-aqueous electrolyte includes a liquid non-aqueous electrolyte and a polymer material for retaining the liquid non-aqueous electrolyte. The polymer material as used herein is a material capable of gelling a liquid material. As for the polymer material, any one commonly used in this field may be used, examples of which include polyvinylidene fluoride, polyacrylonitrile, polyethylene oxide, polyvinyl chloride, polyacrylate, polyvinylidene fluoride, and the like.

The solid electrolyte includes a solute (a support salt) and a polymer material. As for the solute, the same solute as exemplified in the above may be used. As for the polymer material, for example, polyethylene oxide (PEO), polypropylene oxide (PPO), a copolymer of ethylene oxide and propylene oxide, and the like may be used.

The lithium secondary battery of the present invention can be produced in the same manner as a conventional lithium secondary battery. For example, first, the positive electrode, the separator, and the negative electrode are laminated in this order to form a laminated electrode assembly. A positive electrode lead is connected to the positive electrode in the positive electrode core material side, and a negative electrode lead is connected to the negative electrode in the negative electrode core material side. Subsequently, the electrode assembly thus formed is housed in a battery case, the non-aqueous electrolyte is injected into the battery case, and the positive and negative electrode leads are guided outside the battery case. Finally, the battery case is sealed with a sealing material. A laminated lithium secondary battery is thus produced.

Alternatively, the positive electrode and the negative electrode are wound with the separator interposed therebetween, to form a wound electrode assembly. Thereafter, in the same manner as described above, a wound lithium secondary battery is produced.

As for the battery case, the sealing material, and other components, any one conventionally used for a lithium secondary battery may be used without any particular limitation.

### Examples

In the following, the present invention is specifically described with reference to the following examples, comparative examples, and test examples.

### Example 1

### (1) Preparation of Coating Liquid for Use in Formation of Positive Electrode

As the large-particle-size active material, lithium cobalt oxide (LiCoO₂) having an average particle diameter of 7 μm was used. As the small-particle-size active material, lithium cobalt oxide (LiCoO₂) having an average particle diameter of 70 nm was used. The blending ratio (the large-particle-size active material:the small-particle-size active material) was 70:30 (ratio by weight). Here, the blending ratio (ratio by volume=ratio by occupied volume) was expressed as a ratio by weight instead of a ratio by volume, since both the large-particle-size active material and the small-particle-size active material were lithium cobalt oxide (LiCoO₂). In the descriptions below, when the both the large-particle-size active material and the small-particle-size active material were the same compound, the blending ratio was expressed as a ratio by weight instead of a ratio by volume.

Polyvinylidene fluoride (i.e., the binder; weight average molecular weight: 280,000; hereinafter referred to as “PVDF”) was dissolved in an amount of 3 parts by weight in 34.5 parts by weight of N-methyl-2-pyrrolidone (i.e., the dispersion medium; hereinafter referred to as “NMP”), thereby to prepare a binder solution. To the resultant binder solution, 70 parts by weight of lithium cobalt oxide (LiCoO₂) having an average particle diameter of 7 μm, 30 parts by weight of lithium cobalt oxide (LiCoO₂) having an average particle diameter of 70 nm, and 15 parts by weight of acetylene black (i.e., the electrically conductive material) were added and stirred, thereby to prepare the coating liquid for use in formation of a positive electrode of the present invention.

In the coating liquid thus obtained, even after storage for 3 weeks at room temperature, no precipitation or agglomeration of solid components, or no separation of dispersion medium, or the like was observed, and further the properties of liquid such as the initial viscosity were maintained almost unchanged, indicating no deterioration in the film-forming property over time.

### (2) Production of Positive Electrode

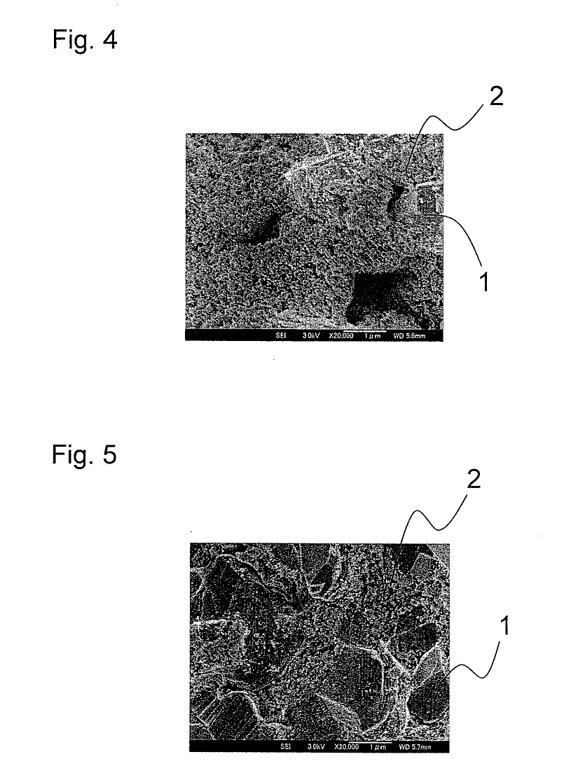

The coating liquid for use in formation of a positive electrode obtained in the above was applied onto both surfaces of a 20-μm-thick aluminum foil (i.e., the positive electrode core material), and dried to form a positive electrode active material layer, whereby a positive electrode plate was formed. The positive electrode active material layers were rolled with rollers at a constant liner pressure, and then the positive electrode plate was cut into a predetermined size, thereby to obtain a positive electrode. The cross sections of the positive electrode active material layers before rolling and after rolling were observed under a scanning electron microscope. FIG. 4 is a scanning electron micrograph of the cross section of the positive electrode active material layer before rolling. FIG. 5 is a scanning electron micrograph of the cross section of the positive electrode active material layer after rolling. From FIG. 4, the small-particle-size active material composed of primary particles that are weakly bonded together surrounds the large-particle-size active material. From FIG. 5, the small-particle-size particles 2 are uniformly dispersed in the gaps between particles of the large-particle-size active material 1.

### Comparative Example 1

A comparative coating liquid for use in formation of a positive electrode was prepared in the same manner as in Example 1 except that lithium cobalt oxide (LiCoO₂) having an average particle diameter of 7 μm was used alone in an amount of 100 parts by weight as the positive electrode active material. In the resultant coating liquid, the precipitation of solid components started after the passage of 1 hour, indicating that the storage stability thereof was significantly inferior to that of the coating liquid of Example 1. Further, a comparative positive electrode was produced in the same manner as in Example 1 except that this coating liquid for use in formation of a positive electrode was used.

### Comparative Example 2

A comparative coating liquid for use in formation of a positive electrode was prepared in the same manner as in Example 1 except that lithium cobalt oxide (LiCoO₂) having an average particle diameter of 70 nm was used alone in an amount of 100 parts by weight as the positive electrode active material. In the resultant coating liquid, no agglomeration or precipitation of solid components, or the like was observed immediately after the preparation, but a slight separation of dispersion medium was observed after storage for 1 week, indicating that the storage stability thereof was inferior to that of the coating liquid of Example 1. Further, a comparative positive electrode was produced in the same manner as in Example 1 except that this coating liquid for use in formation of a positive electrode was used.

### Text Example 1

The viscosity properties of coating liquids prepared in Example 1 and Comparative Examples 1 and 2 were measured at 25° C. using Programmable Rheometer (Model No.: DV-III+, available from Brookfield Engineering Laboratories, Inc) in the following manner. A constant shear is applied for 90 seconds at a rotation number of 0.2, 0.4, 1, 2, 4, 10 and 20, respectively, and then the viscosity after the application of shear was measured.

Further, from the Casson Equation as shown below, the yield value (TO) was calculated.

τ^{1/2}=(η^{∞})^{1/2}·D^{1/2}+(τ₀)^{1/2},

where τ is a shear stress, D is a shear rate, η^{∞} is an infinite viscosity, and τ₀ is a yield value.

The shear stress (τ) can be calculated from the shear rate (D) and the measured viscosity. The infinite viscosity (Υ^{∞}) can be determined as the slope of a straight line obtained by plotting the square root of shear stress against the square root of shear rate (particularly in the high shear rate region) (Casson Plot). Accordingly, by substituting the values of shear stress (τ), shear rate (D), and infinite viscosity (η^{∞}) into the above Casson Equation, the yield value (τ₀) can be calculated. The ratio η₁/η₂ was determined from the viscosity (η₁) measured at a shear rate of 4/sec and the viscosity (η₂) measured at a shear rate of 40/sec. These viscosities were measured using Programmable Rheometer (DV-III+) in the same manner as described above.

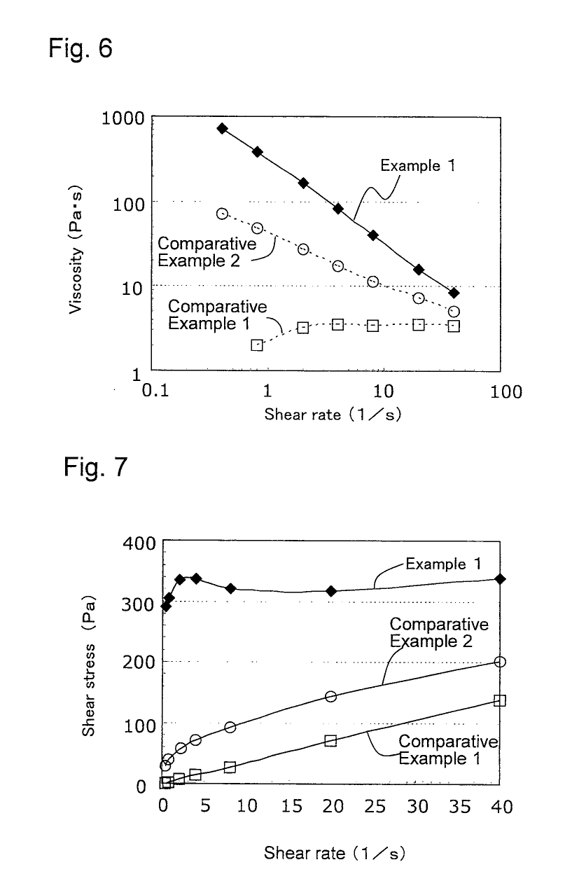

FIG. 6 is a graph showing the relationship between the shear rate and the viscosity in coating liquids of Examples 1 and Comparative Examples 1 to 2. FIG. 7 is a graph showing the relationship between the shear rate and the shear stress in the coating liquids of Examples 1 and Comparative Examples 1 to 2. The yield values and the ratios η₁/η₂ in the coating liquids of Examples 1 and Comparative Examples 1 to 2 obtained from FIGS. 6 and 7 are shown in Table 1.

TABLE 1

| | Yield value (Pa) | η₁/η₂ |
|---|---|---|
| Example 1 | 258 | 9.9 |
| Comparative Example 1 | 15 | 3.5 |
| Comparative Example 2 | 0 | 1.0 |

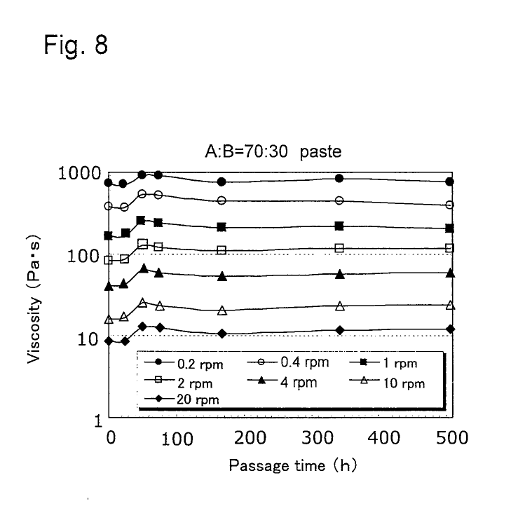

In addition, with regard to the present invention coating liquid of Example 1, a shear force was applied for 90 seconds at the above respective rotation numbers, and thereafter a storage test was performed to check the change in viscosity over time. The results are shown in FIG. 8. FIG. 8 is a graph showing the change in viscosity over time after the application of shear force to the coating liquid of the present invention. FIG. 8 indicates that even after the application of external stress to the coating liquid of the present invention, the storage stability of the coating liquid was not deteriorated, and the viscosity was almost constant and stable even with the passage of time. It is clear, therefore, that the coating liquid of the present invention enables the formation of a positive electrode active material layer in which the large-particle-size active material and the small-particle-size active material are uniformly mixed, the film thickness is almost uniform, and the active material is densely packed.

### Example 2

A coating liquid for use in formation of a positive electrode of the present invention and a positive electrode were produced in the same manner as in Example 1 except that: as the large-particle-size active material, lithium cobalt oxide having an average particle diameter of 20 μm was used; as the small-particle-size active material, lithium cobalt oxide having an average particle diameter of 100 nm was used; and the blending ratio (ratio by weight) was set such that the large-particle-size active material:the small-particle-size active material=50:50. In the coating liquid of the present invention thus obtained, even after storage of 3 weeks, no precipitation or agglomeration, or no separation of dispersion medium, or the like was observed. Further, in the coating liquid of the present invention, the initial properties of liquid were maintained even after storage of 3 weeks, and no deterioration in the film-forming property, the leveling property, or the like was found.

### Example 3

A coating liquid for use in formation of a positive electrode of the present invention and a positive electrode were produced in the same manner as in Example 1 except that: as the large-particle-size active material, lithium cobalt oxide having an average particle diameter of 20 μm was used; as the small-particle-size active material, lithium cobalt oxide having an average particle diameter of 100 nm was used; and the blending ratio (ratio by weight) was set such that the large-particle-size active material:the small-particle-size active material=90:10. In the coating liquid of the present invention thus obtained, even after storage of 3 weeks, no precipitation or agglomeration, or no separation of dispersion medium, or the like was observed. Further, in the coating liquid of the present invention, the initial properties of liquid were maintained even after storage of 3 weeks, and no deterioration in the film-forming property, the leveling property, or the like was found.

### Comparative Example 3

A comparative coating liquid for use in formation of a positive electrode and a positive electrode were produced in the same manner as in Example 1 except that: as the large-particle-size active material, lithium cobalt oxide having an average particle diameter of 20 μm was used; as the small-particle-size active material, lithium cobalt oxide having an average particle diameter of 100 nm was used; and the blending ratio (ratio by weight) was set such that the large-particle-size active material:the small-particle-size active material 40:60. In the coating liquid thus obtained, no clear precipitation of particles was observed immediately after the preparation, but after storage for 3 weeks, a slight separation of dispersion medium was observed, indicating that the storage stability thereof was inferior to that of the coating liquid of the present invention.

### Comparative Example 4

A comparative coating liquid for use in formation of a positive electrode and a positive electrode were produced in the same manner as in Example 1 except that: as the large-particle-size active material, lithium cobalt oxide having an average particle diameter of 20 μm was used; as the small-particle-size active material, lithium cobalt oxide having an average particle diameter of 100 nm was used; and the blending ratio (ratio by weight) was set such that the large-particle-size active material:the small-particle-size active material=95:5. In the coating liquid thus obtained, no clear precipitation of particles was observed immediately after the preparation, but after storage for 1 week, a slight separation of dispersion medium was observed, indicating that the storage stability thereof was inferior to that of the coating liquid of the present invention.

### Comparative Example 5

A comparative coating liquid for use in formation of a positive electrode and a positive electrode were produced in the same manner as in Example 1 except that: as the large-particle-size active material, lithium cobalt oxide having an average particle diameter of 20 μm was used; and as the small-particle-size active material, lithium cobalt oxide having an average particle diameter of 7 μm was used. In the coating liquid thus obtained, even after 1 hour from its preparation, precipitation of particles was observed, indicating that the storage stability thereof was inferior to that of the coating liquid of the present invention.

With respect to the positive electrodes obtained in Examples 1 to 3 and Comparative Examples 1 to 5, the active material filling rate (%) was determined from the following equation. The results are shown in Table 2. In Table 2, the average particle diameters (μm) of the large-particle-size and small-particle-size active materials, the blending ratio (the large-particle-size active material/the small-particle-size active material, ratio by weight), and the average particle diameter ratio (the average particle diameter of the large-particle-size active material/the average particle diameter of the small-particle-size active material) are also shown.

Active material filling rate (%)=(volume of active material in an active material layer/volume of the active material layer)×100

It should be noted that the volume (V1) of an active material layer and the volume (V2) of active material in the active material layer were determined from the equations below. In the calculation, the true density of LiCoO₂ was assumed to be 5.05 g/cm³.

Volume (V1) of active material layer={(Et−Pt)/Esv}×Esr,

where Et represents a thickness of the electrode, Pt represents a thickness of the core material, Esv represents a rate of change between electrode areas before and after pressing, and Esr represents an electrode area after pressing.

Volume (V2) of active material={(Ew−Pw)×(Awr)}/(Ad),

where Ew represents a weight of the electrode, Pw represents a weight of the core material, Awr represents a ratio by weight of active material in the active material layer, and Ad represents a true density of the active material.

TABLE 2

| | Average particle | | | | |
|---|---|---|---|---|---|
| | diameter (μm) | | | | Active |
| | Large- | Small- | Blending | Average | material |
| | particle- | particle- | ration | particle | filling |
| | size active | size active | (Ratio by | diameter | rate |
| | material | material | weight) | ratio | (%) |
| Example 1 | 7 | 0.07 | 70/30 | 100 | 85.1 |
| Example 2 | 20 | 0.1 | 50/50 | 200 | 81.9 |
| Example 3 | 20 | 0.1 | 90/10 | 200 | 81.3 |
| Comparative | 7 | — | 100/0 | — | 73.8 |
| Example 1 | | | | | |
| Comparative | — | 0.07 | 0/100 | — | 58.5 |
| Example 2 | | | | | |
| Comparative | 20 | 0.1 | 40/60 | 200 | 75.8 |
| Example 3 | | | | | |
| Comparative | 20 | 0.1 | 95/5 | 200 | 77.2 |
| Example 4 | | | | | |
| Comparative | 20 | 7 | 70/30 | approx. | 76.6 |
| Example 5 | | | | 2.9 | |

From Table 2, the active material filling rates in the positive electrodes of Examples 1 to 3 exceeded 80%, showing that the filling property was excellent. In contrast, in the positive electrodes of Comparative Examples 1 to 5, the active material filling rates were as small as 58.5 to 77.2%, clearly indicating that the dense packing of active material did not proceed sufficiently. Better results were obtained in Examples 1 to 3 presumably because the coating liquids of Examples 1 to 3 included micron-size active material particles in combination with nano-size active material particles, and the blending ratio between the two materials was suitably selected from the range specified in the present invention. By employing such a configuration as described above, in preparing a coating liquid, the micron-size active material particles prevented the aggregation of nano-size active material particles, while allowing the nano-size active material particles to be dispersed sufficiently in the coating liquid. Presumably, as a result, in forming an active material layer, the nano-size active material particles were almost uniformly packed in the triple points formed by the micron-size active material particles, and thus the active material filling rate was improved.

### Example 4

### (1) Production of Positive Electrode

A 80-μm-thick positive electrode sheet was produced in the same manner as in Example 1.

### (2) Production of Negative Electrode

A negative electrode material mixture slurry was prepared by mixing 75 parts by weight of artificial graphite powder, 20 parts by weigh of acetylene black serving as the conductive agent, and 5 parts by weight of polyvinylidene fluoride resin serving as the binder, and then dispersing these materials in dehydrated N-methyl-2-pyrrolidone. The negative electrode material mixture thus prepared was applied onto the surface of a negative electrode core material made of a 15-μm-thick copper foil, dried, and then rolled to obtain a negative electrode sheet having a thickness of 100 μm.

### (3) Preparation of Non-Aqueous Electrolyte

A mixed solvent of ethylene carbonate (EC) and ethyl methyl carbonate (EMC) (EC:EMC (ratio by volume)=1:3) was mixed in an amount of 100 parts by weight with 2 parts by weight of diallyl carbonate (DAC). To the resultant mixture solution, LiPF₆ was dissolved at a concentration of 1.25 mol/L.

### (4) Assembly of Battery

The positive electrode sheet and the negative electrode sheet were each cut in a size of 35 mm×35 mm, and ultrasonically welded to an aluminum plate and a copper plate each with a lead connected thereto, respectively. The aluminum plate and the copper plate were combined with a polypropylene separator interposed therebetween, such that the positive electrode sheet faces the negative electrode sheet, and then the whole was secured with a tape. Subsequently, the whole was housed in a tubular aluminum laminated pack with both ends open, and then one open end of the pack was welded around the lead portion. Thereafter, the prepared electrolyte was injected dropwise in the pack from the other open end. This intermediate product was charged at a current of 0.1 mA for 1 hour, then degassed at 10 mmHg for 10 seconds, and finally, the open end from which the electrolyte had been injected was sealed by welding, thereby to obtain the lithium secondary battery of the present invention.

### Comparative Example 6

A lithium secondary battery of Comparative Example 6 was produced in the same manner as in Example 4 except that a 120-μm-thick positive electrode sheet produced in the same manner as in Comparative Example 1 was used in place of the positive electrode sheet used in Example 4 having been produced in the same manner as in Example 1.

The batteries of Example 4 and Comparative Example 6 were charged and discharged at a constant current of 2 mA to an upper limit voltage of 4.2 V and to a lower limit voltage of 3.0 V, respectively. The discharge capacities of the batteries measured at this time are shown in Table 3.

TABLE 3

| Battery | Capacity (mAh) |
|---|---|
| Example 4 | 47.5 |
| Comparative Example 6 | 41.2 |

As is evident from Table 3, the lithium secondary battery of Example 4 of the present invention has a capacity higher than that of the lithium secondary battery of Comparative Example 6 by as much as 15% or more.

### INDUSTRIAL APPLICABILITY

The coating liquid of the present invention is suitably used for forming a positive electrode active material layer on the surface of a positive electrode core material and thus for producing a positive electrode for a lithium secondary battery. The lithium secondary battery that includes the positive electrode produced with the use of the coating liquid of the present invention can be used for the same applications as the conventional lithium secondary batteries, and in particular, suitably used as a power source of various portable electronic devices, such as mobile phones, laptop personal computers, personal digital assistants, electronic dictionaries, and game devices.

1. A coating liquid for use in formation of a positive electrode for a lithium secondary battery comprising a large-particle-size active material having an average particle diameter of 1 μm to 20 μm and a small-particle-size active material having an average particle diameter of 5 nm to 100 nm, wherein
the blending ratio by volume of the large-particle-size active material to the small-particle-size active material is from 90:10 to 50:50, and
the ratio of the average particle diameter of the large-particle-size active material to the average particle diameter of the small-particle-size active material is from 50 to 500.

2. The coating liquid for use in formation of a positive electrode for a lithium secondary battery in accordance with claim 1, wherein the coating liquid is a thixotropic fluid having a yield value of 100 Pa or higher.

3. The coating liquid for use in formation of a positive electrode for a lithium secondary battery in accordance with claim 1, wherein the ratio η₁/η₂ of viscosity η₁ at 25° C. measured at a shear rate of 4/sec to viscosity η₂ at 25° C. measured at a shear rate of 40/sec is from 5 to 12.

4. A positive electrode for a lithium secondary battery comprising a positive electrode core material, and a positive electrode active material layer provided on one or both surfaces of the positive electrode core material in the thickness direction thereof, wherein
the positive electrode active material layer contains a large-particle-size active material having an average particle diameter of 1 μm to 20 μm and a small-particle-size active material having an average particle diameter of 5 nm to 100 nm, and has a filling rate of active material is 80% or more.

5. The positive electrode for a lithium secondary battery in accordance with claim 4, wherein the blending ratio by volume of the large-particle-size active material to the small-particle-size active material is from 90:10 to 50:50, and the ratio of the average particle diameter of the large-particle-size active material to the average particle diameter of the small-particle-size active material is from 50 to 500.

6. The positive electrode for a lithium secondary battery in accordance with claim 4, wherein the small-particle-size active material is predominantly present at a triple point in the large-particle-size active material.

7. The positive electrode for a lithium secondary battery in accordance with claim 4, wherein the positive electrode is formed by applying the coating liquid for use in formation of a positive electrode for a lithium secondary battery in accordance with claim 1 on one or both surfaces of the positive electrode core material in the thickness direction thereof and then drying.

8. A lithium secondary battery comprising the positive electrode for a lithium secondary battery of claim 4.
